(19) United States
(12) Patent Application Publication
(10) Pub. No.: US 2008/0201747 A1
(43) Pub. Date: Aug. 21, 2008

(54) System and Method for Aggregating, Editing, and Distributing Content

(75) Inventor: Robin Ross Cooper, La Mesa, CA (US)

Correspondence Address: PROCOPIO, CORY, HARGREAVES & SAVITCH LLP, 530 B STREET, SUITE 2100, SAN DIEGO, CA, 92101, US

(73) Assignee: VERIMATRIX, INC., San Diego, CA (US)

(21) Appl. No.: 11/994,189

(22) PCT Filed: Jun. 30, 2006
(86) PCT No.: PCT/US2006/026001

§ 371 Date: Apr. 23, 2008

Related U.S. Application Data
(60) Provisional application No. 60/695,299, filed on Jun. 30, 2005.

(51) Int. Cl. H04N 7/173

(52) U.S. Cl. 725/93

(57) ABSTRACT

A system and method for the distribution of content to subscribers while maintaining the distribution rights associated with the content. Tags identifying aspects and features, including distribution rights, of the content are associated with the content. The tagged content is aggregated into a centralized data center that receives requests from subscribers to access the content. The tags associated with the requested content are evaluated to determine if the subscriber is authorized to access the content before the content is provided to the subscriber.

### RELATED APPLICATIONS

This application claims the benefit of U.S. Provisional Patent Application Ser. No. 60/695,299, filed Jun. 30, 2005, entitled “System and Method for Aggregating, Editing, and Distributing International Television via Internet Protocol or Data Over Cable (DocSys) Networks,” which is hereby incorporated by reference in its entirety.

### BACKGROUND

1. Field of the Invention

This invention relates to distribution of multimedia content, and more particularly to protecting content providers intellectual property rights when multimedia content is distributed.

2. Description of Related Art

Increased connectivity has provided new, and increased, opportunities for content providers to deliver their content to customers. For example, the proliferation of the Internet now provides a mechanism for content to be easily and inexpensively delivered worldwide. This increased connectivity has greatly expanded the potential audience available to content providers.

While increased connectivity has greatly expanded the potential audience for content it has also raised new problems. For example, it is difficult for content providers to control the distribution of their content once it enters a wide area network, such as the Internet. Typically, a content provider may license content to distributors based upon geographic locations. For example, a television network may license a weekly television show to a broadcaster in one geographic region and to a different broadcaster in a different geographic location. For example, in an over-the-air television broadcast, each broadcaster covers a limited area due to the broadcast signal strength. This limited range of coverage prevented users outside of the geographic region from being able to receive and view the broadcast. Likewise, a cable companies' distribution is limited to the coverage area where it has cable runs to customer premises.

As techniques for distributing content over wide area networks increases, the distribution is no longer limited to a particular geographic region. For example, if a television show is broadcasted on the Internet then users throughout the world can access the content. This world wide distribution capability makes it difficult for content providers to control the distribution of their content. For example, if a content provider wants to limit the distribution of their content to only users within a particular geographic region they can not distribute the content using the Internet and must use other broadcasting techniques.

Thus, there is a need for improved systems and techniques to protect the rights of content providers during distribution of their content.

### SUMMARY

Methods and techniques are described for the distribution of content to subscribers. Aspects include aggregating content that includes receiving content from content providers and encoding the content to a desired format. In addition, tags (sometimes referred to as meta-data) are associated with the content. The tags can identify aspects, or features, about the content. For example, the tags can identify distribution rights associated with the content. The tagged content is then communicated to a data center where the distribution of the content is controlled.

The tagged content can be communicated to the data center in different ways. For example, the tagged content can be communicated over the Internet, through a wireless communication link, such as a cellular, satellite or microwave link, or through a fiber optic link.

The content received from the content providers may be in different forms. For example, the content may be received in analog form and then digitized and encoded into the desired digital format. The content may also be received in different types of digital formats and re-encoded into a desired digital format. Or, the content may be received in the desire digital form from the content provider.

As noted, the tags can be used to identify different aspects or features of the content. For example, a tag can identify the beginning or end of a content sequence, or a tag can identify distribution, or license rights of the content. Also, the tags may be associated with the content using several different techniques. The tags may be included in the content itself, or the tags may be in a file that is associated with the content. Examples of including tags in the content itself include applying tags to the vertical blanking interval of video content, or in a closed caption period of the content, or in a null packet of MPEG encoded content, or adding a watermark to the content.

Additional aspects of the methods and techniques for distribution of content to subscribers includes receiving a request for content from a subscriber, retrieving the requested content from a database, evaluating tags associated with the retrieved content and identifying distribution rights of the content, and then determining if the subscriber is authorized to receive the requested content. There are numerous ways to identify if a consumer is authorized to receive the requested content. Some of the ways to authenticate a consumer can be (but are not limited to) the following:
Consumer is issued a certificate such as an X.509 Digital Certificate
Consumer has an account setup with a service provider and this account is made available after the successful entry of the username and password
Consumer has a biometric device that will capture biometric data such as fingerprint or retinal scan
Consumer can use state-of-the-art authentication means to correctly establish identity
A combination of the methods above can be used
Other methods that achieve a high level of authentication.

If it is determined that the subscriber is authorized to receive the content, then the contact is provided to the subscriber. If it is determined that the subscriber is not authorized to receive the retrieved content, or the requested content is not available in the database, then it is determined if there is substitute content available that the subscriber is authorized to receive and the substitute content is provided to the subscriber As for substitute content, a rich source of meta-data can be collected that carries additional information about the titles that are available to the consumer. By matching the meta-data for the content that is not available with other content selections within the library, it will be possible to identify substitute content files. If it is determined that the requested content is not included in the database and there is no substitute content available that the subscriber is authorized to receive then the subscriber is notified.

Further aspects of the methods and techniques for distribution of content to subscribers include a server. In an exemplary embodiment, the server includes an input module that is adapted to receive encoded content that includes tags identifying distribution rights associated with the content. The input module may also be adapted to receive request from subscribers and information about the characteristics of the subscriber. There is also a memory module that is adapted to store the encoded content. The memory module may be included in the server, or it may be a separate storage device external to the server. A control module processes the request for content from a subscriber, as well as the characteristics of the subscriber, and determines if the requested content is available in the memory module, and if the subscriber is authorized to receive the content based upon the subscriber characteristics and the tags. The server further includes an output module that is adapted to provide content to the subscriber.

The characteristics of the subscriber may include the geographic location for the subscriber. For example, a subscriber may use a digital certificate wherein the certificate is associated with a physical location. Likewise, a subscriber's location may be associated with a DSL or cable modem installation used by the subscriber. In addition, the characteristics of the subscriber many include information about a subscriber's national origin, age, gender, or other information that can be useful in identifying content that may be of interest to the subscriber. Characteristics of the subscriber may be provided with the subscriber's request, or they may have been previously received from the subscriber and stored. Additional subscriber characteristics may contain consumer profile information and usage information as well. For example, the information about the viewing habits and the usage of various viewing platforms (including standard definition TV, High Definition TV, mobile, PC, game player, and other platforms).

The content may be associated with an IP address and the subscriber access the content with a web browser. The subscriber may download the content, or the subscriber may receive the content as streaming content. In addition, the content provided to the subscriber may be time-shifted from the content received by the server.

Other features and advantages of the present invention should be apparent from the following description which illustrates, by way of example, aspects of the invention.

### BRIEF DESCRIPTION OF THE DRAWINGS

FIG. 1 is a block diagram of an exemplary extended content service distribution system.

FIG. 2 is a block diagram illustrating exemplary steps of a content delivery system.

FIG. 3 is a flow diagram of an exemplary embodiment for encoding, tagging and storing content.

FIG. 4 is a flow diagram of an exemplary embodiment for providing requested content to a subscriber.

FIG. 5 is a block diagram of an exemplary server in an extended channel distribution system.

### DETAILED DESCRIPTION

The following detailed description is directed to certain specific embodiments of the invention. However, the invention can be embodied in a multitude of different systems and methods. In this description, reference is made to the drawings wherein like parts are designated with like numerals throughout.

One of the most exciting business opportunities in the 21st century is the customization, or personalization, of broadcast content such as broadcast television. As the technology develops, terms like time-shifting and home-networking are becoming common within the television industry. Experts within the field tend to agree that the television viewing experience of the future will be much different than that of the last 50 years. Consumers will have much more control over the content they receive and how it will be played. Such a concept is sometimes referred to as “MeTV”, meaning, “This is the television programming I want and this is when I want it,” Additionally, new technologies are being created that will allow consumers to watch television on larger, higher resolution screens as well as smaller, lower-resolution devices, such as handheld devices. Continued deployment of high capacity fixed-line, wireless, and hybrid network architectures will also advance the continued development of technologies allowing customization of broadcast content.

Another evolving technology in the new paradigm of customization of broadcast content is Internet Protocol TV (IP-TV). While IP-TV may appear to be similar to traditional television delivery, such as over cable or satellite, there are some fundamental differences. For example, in IP-TV instead of broadcasting all of the available channels at the same time over a high-speed connection to the home, the consumer can select one stream at a time. This “one stream at a time” model provides several benefits. One benefit is that a virtually unlimited number of streams can be offered over the network. That is, large amounts of content can be stored at a server and then desired selections of content can be streamed, or downloaded, to the consumer. Another benefit is that the entire available bandwidth can be used to advantageously communicate the selected content to a consumer. For example, the entire available bandwidth can be used to communicate a selected high definition, or other broadband content, to the consumer.

It is noted that content may be delivered using any high speed, or broadband, network. The content may be broadcast over a digital cable network, over a DSL network, or any other broadband network. These, and other, broadband networks support the “one stream at a time” model as well. For example, the Digital Cable, or Data Over Cable Service Interface Specification (DOCSIS), network can stream content delivered through a data channel rather than a broadcast channel.

The ability to stream a virtually unlimited number of streams of content to consumers at one time allows content to be collected from around the world and provided to consumers that desire the content. In other words, it is possible to go around the world and license as much content, such as broadcast streams, as possible and make the content available to subscribers. For example, the content could be provided to subscribers of IP-TV, DOCSIS Pay-TV, or other distribution networks.

A problem with collecting content from around the world is that there may be potential for overlapping of license rights. For example, a broadcaster in Turkey may have purchased the rights for a movie from a major US motion picture studio. Within the terms of the license arrangement, the broadcaster can only play the movie within the borders of Turkey. If this broadcaster, or content provider, wants to make this content available out outside the borders of Turkey, certain license “rights” may be violated. Therefore, techniques for marking and editing content are needed to allow the broadcaster to sell his broadcast stream, or other content, in another territory trusting that only approved content will be made available to a subscriber, or an end-user.

Once content, such as a broadcast stream, can be legally transported outside of its native country, there is most likely a larger audience for the content. In the above example, ex-patriots from Turkey may be willing to pay an additional monthly fee to their Pay-TV service operator if they can easily gain access to the broadcast stream(s) originating from their home country.

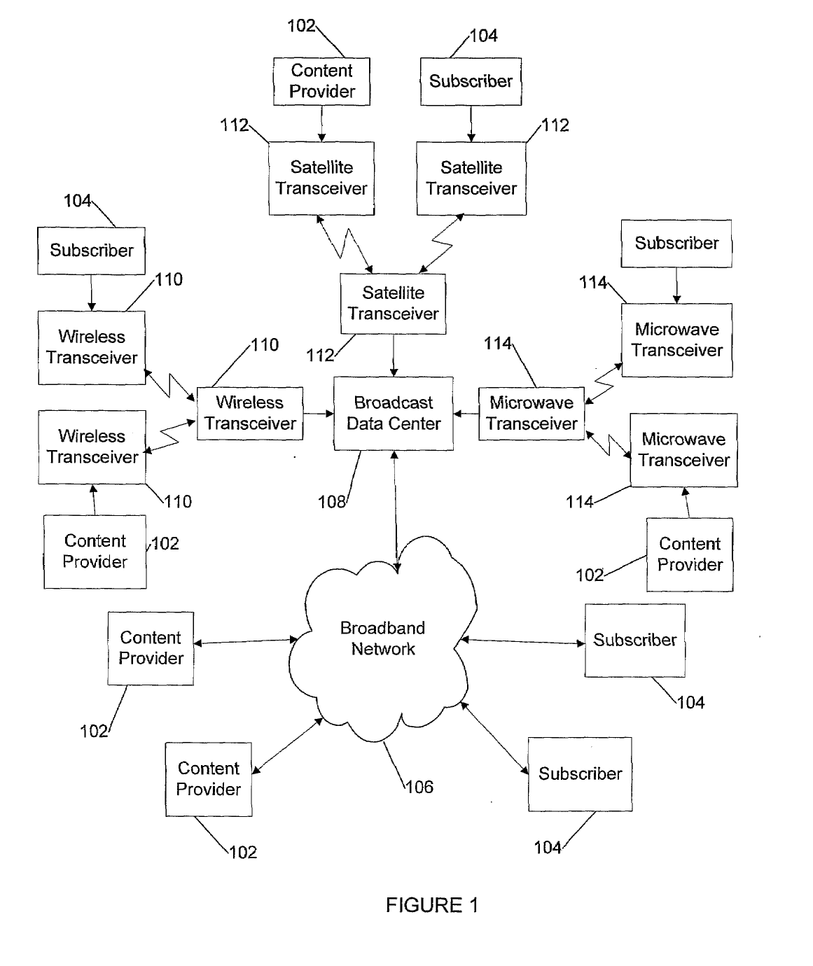

FIG. 1 is a block diagram of an exemplary extended content distribution system. The content distribution system is a delivery system that includes content providers 102 and subscribers 104 who desire access to the content provided by the content providers 102. The content providers 102 and subscribers 104 can send and receive data over a broadband network 106 or other types of networks such as cellular, satellite or microwave networks

Also connected to the broadband network 106 is a broadcast data center 108. The broadcast data center 108 may receive content from the content providers 102 via the broadband network 106. The broadcast data center 108 may also receive content via other communication means. For example, in FIG. 1, the broadcast data center 108 may include, or is in communication with, a wireless transceiver 110 that receives and transmits data with a content provider 102 that also has, or is in communication with, a wireless transceiver 110. The wireless transceivers 110 may communicate using a cellular WiFi, WiMAX, or other wireless network. Likewise, the broadcast data center 108 may include, or be in communication with, a satellite transceiver 112 or a microwave transceiver 114 that receives and transmits data with a content provider 102 that also has, or is in communication with, a satellite transceiver 110 or a microwave transceiver 114.

As noted, the subscribers 204 may receive content from the data center 108 via the broadband network 106. The subscribers 204 may also receive content from the data center 108 via other communication means. For example, in FIG. 1, a subscriber 104 may include, or is in communication with, a wireless transceiver 110 that receives and transmits data with the data center 108 that also has, or is in communication with, a wireless transceiver 110. Likewise, the subscriber 104 may include, or be in communication with, a satellite transceiver 112 or a microwave transceiver 114 that receives and transmits data with the data center 108 that also has, or is in communication with, a satellite transceiver 110 or a microwave transceiver 114.

In general, the broadcast data center 108 collects content from the various content providers 102. The broadcast data center 108 will then distribute content to the subscribers 104. As described further below, the content is adapted to include tags that identify various intellectual property rights and other aspects about the content. The broadcast data center ensures that the property rights are observed during the distribution of the related content.

The broadcast data center 108 can put the tags into the content, or the tags can be entered into the content before the broadcast data center 108 receives the content. The broadcast data center 108 can also edit the content before it is distributed. The broadcast data center 108 can take steps to both license numerous broadcast streams from around the world and keep these streams from violating any license terms with third party content providers. It is noted that the broadcast data center 108 is not necessarily the entity that needs to license, or option, the various content. That is, the content can be licensed by others, such as the content provider, and the licensing information included within the content such that the broadcast data center 108 restricts distribution of the content in accordance with the license.

The broadcast data center 108 offering the content can additionally bundle info-mercials for the purpose of gaining additional revenues. These info-mercials can be targeted toward finely focused groups of potential consumers. If characteristics about the subscriber are known, then the info-mercials can be selected in accordance with the characteristics. For example, the info-mercials could be targeted to subscribers who are enthusiasts of mountain biking, rock climbing, surfing, knitting, etc.

### Number of Viable Channels

With the structure of existing broadcast television, it is possible there is some confusion within the industry regarding the maximum number of channels that are marketable at any one given time. Because the total number of channels that can be broadcast by a typical cable or satellite network currently tends to be around 120, it is often assumed that these are all the attractive channels available in the world. However, it is unlikely that the limit of marketable channels is such a low number, rather it may be determined that 1000 or 10,000 channels may be a much more appropriate number.

Licensing Content from Around the World

One technique for licensing content, such as broadcast streams, would be for representatives of the broadcast data center to travel around the world and either license or option the various content. In this technique, separate negotiation session could be conducted with each content provider or broadcaster or, license or option deals can be conducted with groups of content providers as well.

Another technique for licensing content is for the broadcast data center to establish a set of standard procedures to protect content in response to standardized tags. That is, there can be a set of standard tags that a content provider, or broadcaster, can include within their content, and the broadcast data center will restrict the distribution of the content in accordance with the tags. For example, a unique tag can be assigned to every country in the world. Then, when a content provider agrees to license content to a particular region, the content provider can include the appropriate country tag.

In the example above, where a movie was licensed for broadcast within the borders of Turkey, the content provider would include the tag corresponding to Turkey with the content. Then, when the broadcast data center received the content it would identify the tag and know that that particular movie could not be distributed to subscribers outside of Turkey. However, the license may also allow for ex-patriots of Turkey to also view the content. Then, if a subscriber is characterized as an ex-patriot of Turkey the broadcast data center will allow the subscriber access to the content. Knowledge of characteristics of a subscriber can be obtained by the broadcast data center in various ways. For example, a subscriber may use a digital certificate that is associated with a physical location, or a location may be associated with a DSL or cable modem installation used by the subscriber, or the subscriber may fill out a questionnaire and identify various characteristics. An interview process such as a VeriSign Class 3 interview could also be performed where a well known company such as Verisign will verify the ex-patriot status of the subscriber. Other means of identifying subscriber country status can be used as well.

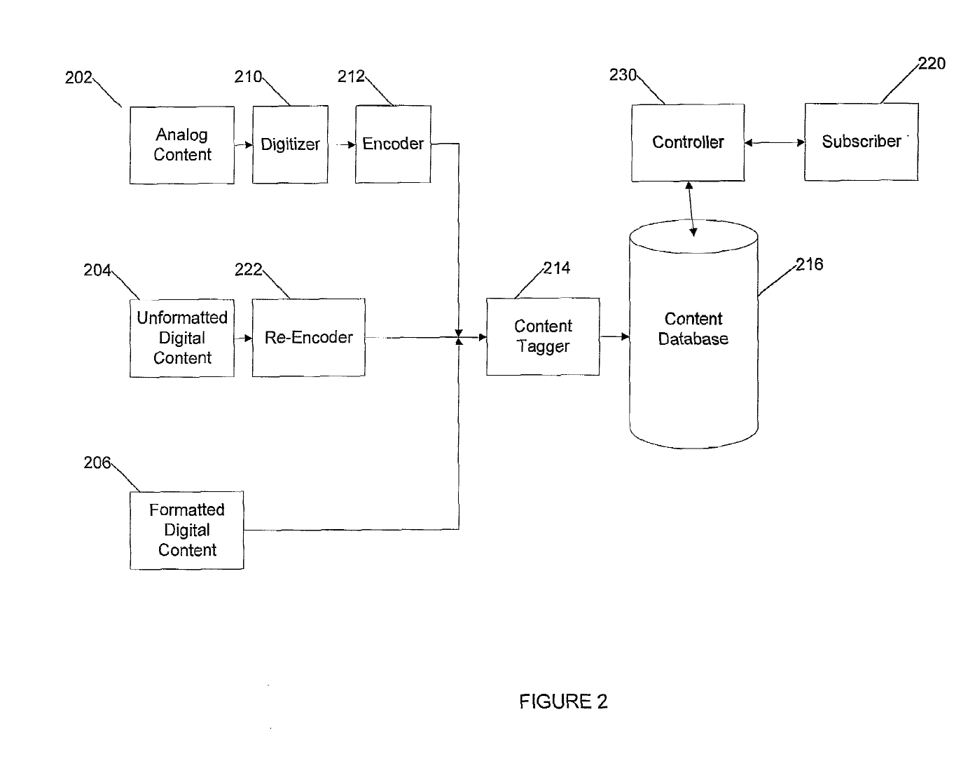

FIG. 2 is a block diagram illustrates exemplary steps of a content delivery system. As shown in FIG. 2 content may enter the system as either analog content 202, unformatted, or incorrectly formatted, digital content 204, of correctly formatted digital data 206

If the content is received as in analog form, then the content goes to a digitizer 210. The digitalization of the analog data can be accomplished using, for example, state-of-the-art encoding technologies offered by well-known companies such as Harmonic, Tandberg, Optibase, Modulous, or any other appropriate digitizer. The output of the digitizer 210 then passes to an encoder 212 where it is encoded into the desired format. For example, the encoder may format the data in accordance with MPEG-2, MPEG-4, MPEG-4 AVG, or other standardized format.

After the analog data has been digitized and encoded it is processed by a content tagger 214. The content tagger 214 can include tags within the content or create a tag file that is associated with the content. The tags can identify, for example, the beginning of a content sequence, the end of a content sequence, information about the appropriate distribution of the content. The tags may also include information about the type of audience that the content is appropriate for, such as a rating system for a movie. The tagged content, or content and the associated tag file, is then communicated to a content database 216 where it is stored and can be retrieved for access by subscribers 220.

If the content is received as unformatted or incorrectly formatted digital content 204, then the content goes to a re-encoder 222. The re-encoder 222 is adapted to receive digital data in one format, or unformatted, and to convert it to another format. For example, re-encoder 222 can be adapted to accept digital data format in accordance with the MPEG-2 standard and convert it to the MPEG-4 standard format, or to convert data formatted as an MPEG-4 simple profile and convert it to MPEG-4 AVC format, or any other combinations of data formats.

After the digital data has been converter to the desired format it is processed by the content tagger 214. As described above, the content tagger 214 includes tags within the content, or creates a tag file associated with the content, that can identify features and characteristics of the content and its distribution rights. The tagged content and any associated tag file is then communicated to the content database 216 where it is stored and can be retrieved for access by subscribers 220.

If the content is received as correctly formatted digital content 206, then the content is processed by the content tagger 214 where tags are included in the content or an associated tag file. The tagged content and any associated tag file is then communicated to the content database 216 where it is stored and can be retrieved for access by subscribers 220.

The digitizer 210, encoder 212, re-encoder 222, and content tagger 214 may be located at the content provider, or at the broadcast data center, or distributed between the content provider or broadcast data center. These aspects may also be provided by third parties that will process the content received from content providers. For example, a third party may digitize and encode content received from a content provider and the broadcast data center may tag the content files. Likewise, third parties may digitize, encode, and tag the content and then provide tagged content to the broadcast data center, or the content provider can process the content and deliver properly formatted and tagged content to the broadcast data center. Content transferred from the content provider, or third parties, to the broadcast data center can be accomplished by a variety of techniques, for example, filed transfer protocol (FTP), high-speed wireless, satellite, micro-wave, sneaker-net, etc.

In one embodiment, a subscriber 220 may communicate a request for content to a controller 230. The controller 220 will then search the content database 216 to determine if the requested content is stored in the content database 216. If the requested content is available, then the controller 230 will evaluate the tags included within the content to determine if the subscriber 220 is authorized to receive the requested content.

The subscriber 220 may provide the controller 230 with information about characteristics about the subscriber 220 which the controller 230 will use in determining if the subscriber is authorized to receive the requested content. For example, the subscriber may send the request through a pay-per-view service that will notify the controller 230 that the subscriber 220 is authorized to receive the requested content. In addition, the subscriber 220 may provide information about characteristics of the subscriber 220. The controller 230 may then use the information received from the subscriber 220 when determining if the subscriber is authorized to receive the requested content or in trying to identify any substitute, or other, content that may be of interest to the subscriber.

If the controller 230 determines that the subscriber is not authorized to receive the requested content, then the controller 230 will notify the subscriber that the subscriber is not authorized to receive the requested content. The controller may provide the subscriber 220 with an option to view other substitute content that is available in the content database 216 that is similar, or otherwise related, to the requested content, and that the subscriber 220 is authorized to receive. For example, if the subscriber 230 requested to receive an western movie, but the subscriber 230 was not authorized to receive the requested western movie, for example due to regional licensing restrictions, then the controller 230 could provide the subscriber 220 a list of alternate, or substitute, western movies which the subscriber 230 is authorized to receive. If the subscriber 220 indicates that they want to view one of these substitute westerns then the controller 230 can provide it to the subscriber 220. Substitute content can be identified in numerous ways including the matching of the characteristics of the desired content with the characteristics of other substitute titles. Other matches can include titles that match the profile of the subscriber (i.e. subscribers that typically enjoy westerns also tend to enjoy titles about space travel.) Still another example is the use for a sophisticated system such as a neural network that can ingest a large amount of data (including subscriber profile information, device or platform information, and profile information for the geographical region) and make selection for possible substitute titles.

If the controller 230 determines that the subscriber is not authorized to receive the requested content, and the controller 230 can not find any alternative content to suggest for the subscriber 220, then the controller 230 will notify the subscriber 220 that they are authorized to view the requested content. The subscriber 220 may then make another request for different content.

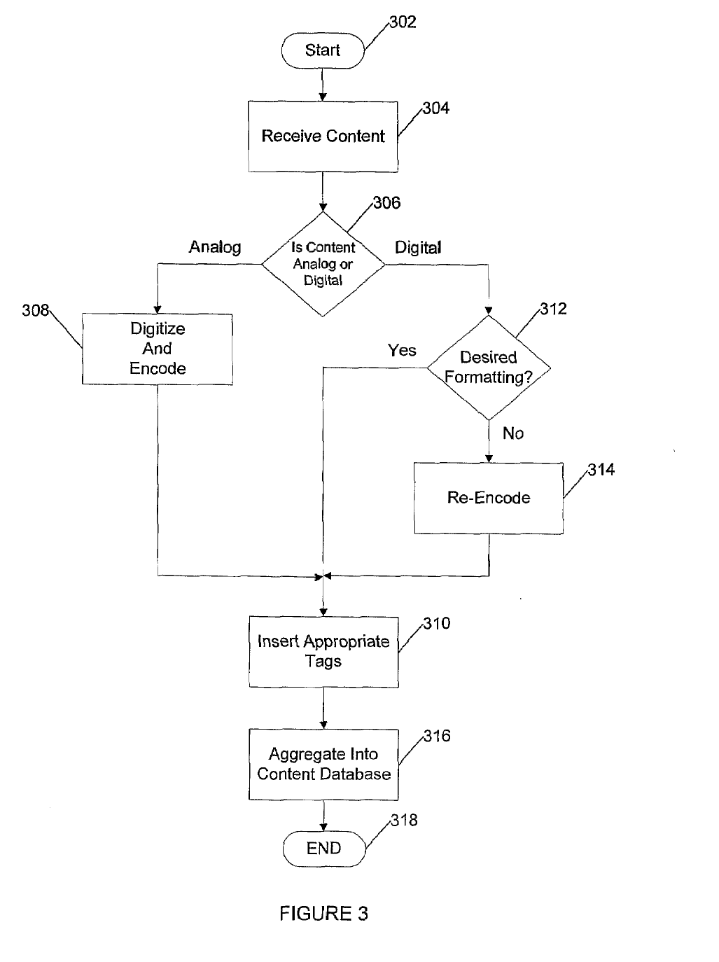

FIG. 3 is a flow diagram of an exemplary embodiment for encoding, tagging and storing content which can be carried out by the system in FIG. 2. Flow begins in block 302. Flow continues to block 304 where content is received. The content may be any type of media, for example, movies, videos, broadcast television, images music, text files, or any other type multimedia or electronic content. Flow continues to block 306 where it is determined if the received content is in analog or digital format. If the content is in analog format flow continues to block 308. In block 308 the analog content is digitized into digital content and encoded into a desired digital format. Flow then continues to block 310.

Returning to block 306, if the received content is in digital format flow continues to block 312. In block 312, it is determined if the received digital content is in the desired format. If the content is in the desired format, a positive outcome, then flow continues to block 310. In Block 312, if it is determined the received digital content is not in the desired format, a negative out come, then flow continues to block 314. In block 314 the digital content is re-encoded into the desired format. Flow then continues to block 310.

In block 310 tags are inserted into the content or a tag file is associated with the content. The tags can indicate different aspects or features of the content. For example, the tags can identify the beginning or end of a sequence of content, or identify distribution rights associated with the content, or features such as the age appropriateness of the content, or other features or aspects of the content. The tags may be inserted into the content itself, or they may be stored in a file associated with the content.

Examples of tags that can be associated with the content can include one tag representing the start of local news broadcast. Another tag representing the end of the same local news broadcast. Yet a third tag may indicate the start of a movie sourced from Hollywood. A fourth tag may indicate the end of the same Hollywood movie, and so forth. Additionally, tags may include information about distribution rights associated with the content.

In one embodiment, the content providers, like broadcasters, from around the world will be given technologies and guidelines that will assist them in tagging various sections of the content, or broadcast streams. For example, watermarking technologies, in video or audio, can be used to place small, invisible markings into the content file itself. These markings can be effective in providing information to automated systems within the data center that are looking to edit the incoming streams. Technologies other than watermarking can also be used. Examples of other marking techniques may include placing marks in the vertical blanking interval of a video signal, placing marks in the closed caption portion of a broadcast, placing marks in NULL packets of MPEG data. Tagging can be any technique where the tags are associated with the content is such a way that the tags do not disrupt a subscriber's enjoyment of the content and provides the data center with information that can be used in deciding if a particular subscriber is authorized to receive the content.

In some cases, certain content providers may need to perform the tagging function manually, such as by having trained personnel tag the content, until the content provider can obtain equipment and software that will perform the necessary marking functions automatically.

Once the tags have been added to, or associated with, the content flow continues to block 316. In block 316 the content and associated tags are aggregated into a content database. The content database stores the tagged content allowing it to be retrieved and provided to authorized subscribers. Flow continues to block 318 where flow ends.

In another embodiment, the various content, for example, broadcast streams, are aggregated and then the tags are added to the content. For example, the content can be aggregated into servers operated at a broadcast data center, then each piece of content can be tagged.

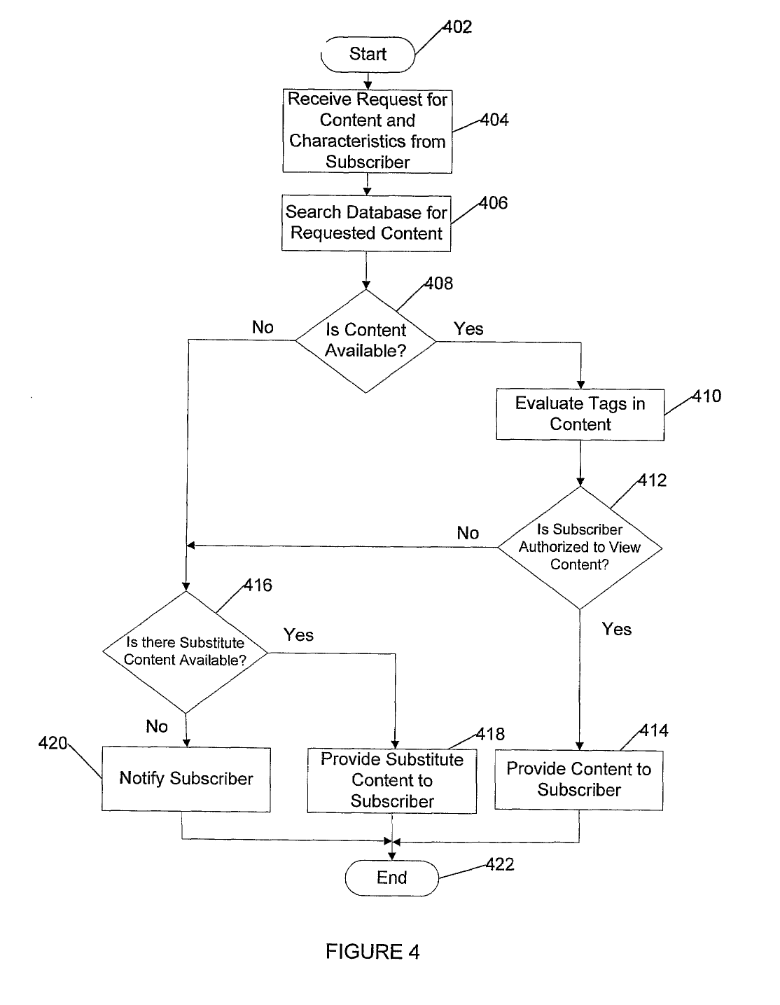

FIG. 4 is a flow diagram of an exemplary embodiment for providing requested content to a subscriber which can be carried out by the system in FIG. 2. Flow begins in block 402. Flow continues to block 404 where a request for content is received from a subscriber. The subscriber can also provide characteristic information or characteristic information about the subscriber could have been previously collected or otherwise obtained. Examples of characteristics of the subscriber include geographic location, age, gender, usage behavior, educational background, viewing habits, and others. Flow then continues to block 406 where a database is searched to determine if the requested content is available. For example, a controller in a data center may receive the request from the subscriber, and the controller may search a database. Flow continues to block 408 where it is determined if the requested content is available. If the requested content is available, a positive outcome, flow continues to block 410.

In block 410 tags associated with the content are evaluated. The tags may be included with the content itself, or the tags may be stored in a separate file associated with the content. Flow then continues to block 412 where it is determined if the subscriber is authorized to receive the requested content. In one example, the content may be provided on a pay-per-view basis, and the identity of all authorized subscribers may be provided to the system by the pay-per-view operator. In another example, a list of authorized subscribers may be provided by the pay-per-view operator at the time the request is made. In yet another example, the subscriber provides information, along with the request, or the subscriber has previously provided information to the system, and this information may be used in determining if the user is authorized to receive the desired content. In yet another example, the distribution rights to the content are compared to information about the subscriber to determine if the subscriber is authorized to receive the content. For example, a section of content may be licensed to a specific geographic region and the subscriber is authorized to receive the content only if the subscriber is located with the region.

Additional ways to identify if a consumer is authorized to receive the requested content can include, for example, issuing a certificate such as an X.509 digital certificate to a consumer, or the consumer can setup an account with a service provider and this account is made available after the successful entry of the username and password. Other examples of techniques for verifying a consumer is authorized to receive content include a biometric device that will capture biometric data of a consumer, such as fingerprint or retinal scan, or other state-of-the-art authentication means to correctly establish a consumer's identity. N addition, any combination of the techniques above can be used, as well as other methods that achieve a high level of authentication.

If it is determined that the subscriber is authorized to receive the content, a positive outcome at block 412, then flow continues to block 414 and the content is provided the content. If it is determined that the subscriber is not authorized to receive the content, a negative outcome at block 412, then flow continues to block 416. Returning to block 408, if it was determined that the content requested by the subscriber is not available, a negative outcome at block 408, then flow also continues to block 416.

In block 416, it is determined if there is substitute content available that the subscriber is authorized to receive. As note, the substitute content may be content that is similar or otherwise related to the requested content. If there is appropriate substitute content available, a positive outcome at block 416, then flow continues to block 418 and the substitute content or a list of the substitute content may be provided to the subscriber. If the subscriber desires to receive any of the substitute content, the subscriber selects the desired content on the list and that content is provided to the subscriber.

Returning to block 416, if it is determined that there is no appropriate substitute content available, a negative outcome at block 416, then flow continues to block 420. In block 420, the subscriber is notified that the requested content is not available, or that the subscriber is not authorized to receive the requested content, and that there is no appropriate substitute content available. Flow continues from blocks 420, 418, and 414 to block 422 where flow ends.

Many of the aspects described can be automated. For example, if a broadcast stream from a host country is communicated to the data center, once the sections of the content are appropriately tag, or marked, an automated system can read all markings in order to determine which content sections will remain and which content sections will need to be deleted from the content or stream. Once a section is deleted, it can be replaced with appropriately licensed content from another source, or a black screen may be inserted until the next fully licensed section becomes available. In this example, a newly created stream of content will contain as much of the original broadcast material from the host country as possible with the exception of the newly inserted sections of content that are used to replace the un-licensed portion of the stream.

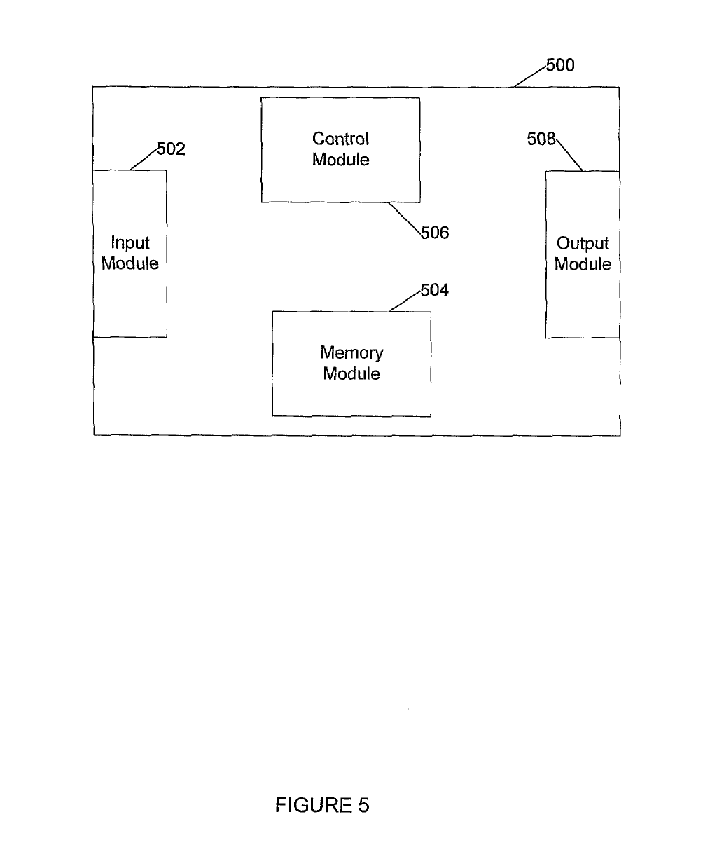

FIG. 5 is a block diagram of an exemplary server in an extended channel distribution system that can carry out the operations described in FIGS. 3 and 4. As shown in FIG. 5, the server 500 includes an input module 502 that is adapted to receive encoded content that includes tags identifying distribution rights associated with the content. The input module 502 may also be adapted to receive request and characteristics from subscribers. There is also a memory module 504 that is adapted to store the content. The memory module 504 may be included in the server, or it may be a separate storage device external to the server. A control module 506 processes the request for content from a subscriber, as well as characteristics of the subscriber. The controller 506 determines if the requested content is available in the memory module 504, and if the subscriber is authorized to receive the content based upon the subscriber characteristics and the tags. The server 500 further includes an output module 508 that is adapted to provide content to the subscriber.

The output module 508 provides the content to the subscriber if the subscriber is authorized to receive the content. If the subscriber is not authorized to receive the content, or the requested content is not included in the memory module 504, then the control module 506 determines if there is substitute content available that the subscriber is authorized to receive and the output module 508 provides the substitute content to the subscriber. If the subscriber is not authorized or the requested content is not included in the memory module 504 and the control module 506 determines that there is no substitute content available, then the output module 508 notifies the subscriber.

The content provided to the subscriber can be associated with an IP address. The subscriber can then access the content using a web browser. The content can be streaming content or the subscriber can download the content. The content provided to the subscriber can also be time-shifted from the content received by the server. For example, if the server receives content from a content provider at a time that is not convenient for the subscriber, the content may be delayed, or shift, to a time that is more convenient for the subscriber to access the content.

Delays Introduced into the Process

In an embodiment, content, such as a broadcast stream, needs to be encoded, tagged, marked, transferred to a data center, and then processed to determine if subscribers are authorized to receive the content, which can be carried out by the system depicted in FIG. 2, delays between the original viewing time and the time it becomes available to others will be introduced. For example, a broadcast stream that played at 6:00 pm Greenwich Mean Time may not be available to be streamed until 9:00 pm or even 10:00 pm Greenwich Mean Time. In a target country where a subscriber wants to receive the broadcast stream, such a delay may push the availability of the stream into a timeframe that is unacceptable to the viewing audience. Given these delays, it may be preferred to schedule the playing of these broadcast sections for times that are more convenient for the target market. Scheduling of broadcast streams may be an important aspect in providing content to subscribers.

### A Separate Channel for Each Content Stream

Once content streams have been appropriately processed and otherwise prepared for subscribers, then each stream may be directed to its own Internet Protocol (IP) address, by a content stream module. There are a number of such “streamers” today that can perform this function. One such “streamer” is manufactured by a company named SkyStream. Another such “streamer” is manufactured by Tandberg. When it is time to add another stream to the list, the data center only needs to assign another IP address and make sure that a menuing system, or middleware, can match the stream with the recently assigned IP address. Likewise, if the data center needs to remove a stream from the service, it will simply un-assign the content's IP address.

The Subscriber's Method of “Tuning” into Each Content Stream

A subscriber will be able to “tune-in” to each content stream by directing a client device, for example a PC, set-top-box, wireless, hand-held device, or other web enabled device, to the correct IP address using a browser module. Once the client device has switched itself to the appropriate IP address, the content can be streamed, or downloaded, to the client device so the subscriber can enjoy the content

### Digital Rights Management

Although many types of broadcast content are considered perishable, because their value only lasts for a limit time, such as a few hours, it is important to offer a Digital Rights Management system (DRM) module in case it becomes a requirement for any of the potential content providers. A DRM system such as the one offered by Verimatrix, Inc. of San Diego, Calif., can be used to protect the content from its original source all the way to the client device. By using Verimatrix's DRM system along with any counter-part client modules, the content can be protected from end-to-end.

### Dubbing, Subtitles, and Localization

Some content streams may be attractive for business, governmental and educational reasons, rather than for simple viewing or listening enjoyment. Using an editing and localization module content may be adapted for a particular user or groups of users. For example, a commodities trader may want to watch a program that explains this year's yield of cotton in China. Obviously, such a viewer is only interested in gathering information that might help him to be successful in his business. Therefore, the data center can provide language dubbing services, subtitling, and other localization services for a fee.

### Middleware

The systems and method described above can become very complicated for the potential subscribers over time. A user interface module can be used by a subscriber to assist in identifying content that is of interest to the subscriber. For example, there is the potential for a large number of content streams, each with its own viewing schedule, to be available and thereby make the system complex and difficult for a subscriber to use. Therefore, a sophisticated middleware system can be provided that helps to “mine” the available data based on preference settings previously established by the subscriber. For example, preference settings may be indicated using natural language queries like, “please find anything to do with cooking lobsters and save it to a long-term-storage device so I can watch it at my leisure.” By using an appropriately sophisticated middleware system, these sources of information can easily be mined and navigated per the subscriber's request.

### Download Model

In some cases, subscribers may not have the ability, or desire, to receive a real-time stream of content from a data center as described above. For example, it may be the case that the subscriber's network connections are simply too slow to support the real-time stream. In these cases, the data center can offer streams based on a download module. This download module has a system of menus, or middleware, allowing the content will be downloaded to the client device rather than be streamed.

### Alternative Embodiments

In one embodiment, a multiplicity of broadcast streams can be collected from host countries or sources, tagged, marked, edited, time-shifted, and then streamed or downloaded to subscribers using an IP Address as the pointer to the content. Such an offering may be of particular interest, for example, to ex-patriots living around the world who may pay a premium for such a service. Business, governments, and educators may also be interested in such a service offering.

In other embodiments, telephone companies and cable companies may decide to offer such a service thereby gaining a competitive advantage, for example, over satellite offerings that currently have no ability to “tune” into individual IP addresses. It is envisioned such a network of “extended viewing channels” may be strategic and commercially viable for a number of service operators looking for new product offerings and differentiation.

In another embodiment, an entity may contact content providers around the world and either license or option, the available content, such as broadcast feeds. The content may then be encoded into a desired digital format. Then, the content is tagged, either manually or automatically. Content tags may, for example, identify the start and end points of the discreet sections of the content, or the distribution rights associated with the content. The encoded and tagged content may then be communicated to one or more high-capacity data centers. The content may be communicated to the data center in many different ways, for example, through a broadband network, such as the Internet, through wireless communication links such as cellular, satellite and microwave links.

At the data center an automated or manual system may evaluate the tags in the content and edit the content accordingly. For example, the tags may be evaluated to determine which portions of the content should stay in the content and which portions need to be either deleted or edited. The system may insert, delete, or edit the content streams as appropriate in order to verify that distribution and license “rights” are not being violated.

After the content has been appropriately edited, each selection of contact may be assigned to an IP address. A middleware or menuing system may match the edited content with their assigned IP address. The edited content may also be time-shifted to an appropriate time slot. In addition, the content may include dubbing, subtitling, and other localization services. There can also be additional techniques that assist a subscriber to perform “data mining” on the available content. The content may be streamed to the subscriber. Further, if the subscriber's connection to the data center is not adequate, or if the subscriber would prefer, the content may be downloaded rather than streamed.

The foregoing description details certain embodiments of the invention. It will be appreciated, however, that no matter how detailed the foregoing appears, the invention may be embodied in other specific forms without departing from its spirit or essential characteristics. The described embodiments are to be considered in all respects only as illustrative and not restrictive and the scope of the invention is, therefore, indicated by the appended claims rather than by the foregoing description. All changes, which come with the meaning and range of equivalency of the claims, are to be embraced within their scope.

1. A method of aggregating content, the method comprising:
receiving content;
encoding the content;
associating tags with the content, wherein the tags identify distribution rights associated with the content;
communicating the tagged content to a data center.

2. The method as defined in claim 1, wherein communicating the tagged content to the data center comprises transmitting the tagged content over the Internet.

3. The method as defined in claim 1, wherein communicating the tagged content to the data center comprises a wireless communication link.

4. The method as defined in claim 1, further comprising storing the tagged content at the data center.

5. The method as defined in claim 1, wherein encoding the content comprises encoding the content in accordance with an MPEG standard.

6. The method as defined in claim 1, wherein associating tags with the content comprises a file associated with the content wherein the file includes the tags.

7. The method as defined in claim 1, wherein associating the tags comprises identifying license rights of the content.

8. The method as defined in claim 1, wherein associating tags with the content comprises including tags within the content.

9. The method as defined in claim 8, wherein including tags within the content comprises applying tags in a vertical blanking interval of the content.

10. The method as defined in claim 8, wherein including tags within the content comprises applying tags in a closed caption portion of the content.

11. The method as defined in claim 8, wherein including tags within the content comprises applying tags in null packets of MPEG encoded content.

12. The method as defined in claim 8, wherein including tags within the content comprises applying tags as a water mark within the content.

13. A method of distributing content, the method comprising:
receiving a request for content from a subscriber;
retrieving the requested content from a database;
evaluating tags associated with the content, wherein the tags identify distribution rights of the content; and
determining if the subscriber is authorized to receive the content.

14. The method as defined in claim 13, wherein if the subscriber is authorized to receive the content then providing the content to the subscriber.

15. The method as defined in claim 13, wherein if the subscriber is not authorized to view the retrieved content it is then determined if there is substitute content available that the subscriber is authorized to receive and proving the substitute content to the subscriber.

16. The method as defined in claim 13, wherein if the requested content is not included in the database it is then determined if there is substitute content available that the subscriber is authorized to receive and providing the substitute content to the subscriber.

17. The method as defined in claim 13, wherein if the requested content is not included in the database and there is no substitute content available that the subscriber is authorized to receive the subscriber is notified.

18. The method as defined in claim 13, wherein determining if the subscriber is authorized to receive the content comprises comparing the distribution rights of the content to a geographic location of the subscriber.

19. The method as defined in claim 18, wherein the geographic location of the subscriber is included within a digital certificate used by the subscriber.

20. The method as defined in claim 13, further comprises providing the content to the subscriber if the subscriber is authorized.

21. The method as defined in claim 20, wherein providing the content comprises associating the content to an IP address.

22. The method as defined in claim 20, wherein providing the content comprises streaming the content to the subscriber.

23. The method as defined in claim 20, wherein providing the content comprises downloading the content to the subscriber.

24. A server system comprising:
an input module adapted to receive encoded content, wherein the encoded content comprises tags identifying distribution rights associated with the content, the input module is also adapted to receive a request for content from a subscriber and characteristics of the subscriber;
a memory module adapted to store the encoded content;
a control module adapted to process the request for content from the subscriber and characteristics of the subscriber, determine if the requested content is available in the memory, and if the subscriber is authorized to receive the content based upon the subscriber characteristics and the tags; and
an output module adapted to provide content to the subscriber.

25. The server as defined in claim 24, wherein the output module provides the content to the subscriber if the subscriber is authorized to receive the content

26. The server as defined in claim 24, wherein if a subscriber is not authorized to receive the content, or the content is not in the memory module, then the control module determines if there is substitute content available that the subscriber is authorized to receive and the output module provides the substitute content to the subscriber.

27. The server as defined in claim 24, wherein the tags associated with the content comprise distribution rights of the content.

28. The server as defined in claim 24, wherein the characteristics of the subscriber include a geographic location of the subscriber.

29. The server as defined in claim 24, further comprising associating a stream of content with an IP address.

30. The server as defined in claim 24, wherein the subscriber downloads the content.

31. The server as defined in claim 24, wherein the subscriber is provided the content as streaming content.

32. The server as defined in claim 24, wherein content provided is time-shifted from the received content.

33. A method of providing content to subscribers, the method comprising:
receiving content;
encoding the content;
associating tags with the content, wherein the tags identify distribution rights associated with the content;
storing the tagged content in a database;
receiving a request for content from a subscriber;
retrieving the requested content from the database;
evaluating the tags associated with the content and characteristics associated with the subscriber and determining if the subscriber is authorized to receive the content.

34. The method as defined in claim 33, further comprising providing the content to the subscriber if the subscriber is authorized to receive the content

35. The method as defined in claim 33, wherein if the subscriber is not authorized to view the content, or the content is not in the database, determining if there is substitute content available that the subscriber is authorized to receive providing the substitute content to the subscriber.

36. The method as defined in claim 33, wherein the characteristics of the subscriber include a geographic location of the subscriber.

37. The method as defined in claim 33, further comprising associating a stream of content with an IP address.

38. The method as defined in claim 33, further comprising downloading of the content by the subscriber.

39. The method as defined in claim 33, further comprising streaming the content to the subscriber.

40. The method as defined in claim 33, further comprising time-shifting the content provided to the subscriber.
